(19) United States
(12) Patent Application Publication
(10) Pub. No.: US 2017/0072915 A1
(43) Pub. Date: Mar. 16, 2017

(54) METHOD FOR DE-ICING A VEHICLE WINDOW

(71) Applicant: Valeo Systèmes d'Essuyage, Le Mesnil Saint Denis (FR)

(72) Inventors: Grégory Kolanowski, Siaugues-Saint-Romain (FR); Giuseppe Grasso, Le Breuil sur Couze (FR); Marcel Trebouet, Chavenay (FR); Pierre-Emmanuel Negre, Paris (FR)

(73) Assignee: Valeo Systèmes d'Essuyage, Le Mesnil Saint Denis (FR)

(21) Appl. No.: 15/266,366

(22) Filed: Sep. 15, 2016

(30) Foreign Application Priority Data
Sep. 15, 2015 (FR) 1558608
Sep. 18, 2015 (FR) 1558782

(51) Int. Cl. B60S 1/52; B60S 1/50

(52) U.S. Cl. CPC B60S 1/524; B60S 1/50

(57) ABSTRACT

Method for washing a window of a motor vehicle, using a device comprising:
at least one tank containing a de-icing fluid,
a tube system connecting the at least one tank to openings through which the fluid is sprayed onto the window,
a supply pump designed to circulate the fluid in the tube system until it is ejected via the aforesaid openings, and
at least one wiper blade suitable for moving over the window through the action of a drive motor,
   characterized in that it comprises:
a) a division of the angular sector swept by said at least one blade into elementary sectors, and
b) over at least one elementary sector, a modulation of the exit pressure from the supply pump between a “nominal” pressure and a non-zero pressure that is less than this nominal pressure.

The technical sector of the present invention is that of methods for washing and, more particularly, for de-icing a vehicle window, particularly a window of a motor vehicle, using a device for wiping and washing or de-icing said window.

Automobiles are commonly equipped with wiper units and washing systems for wiping and washing the windscreen, thereby preventing disruption to the driver's view of his surroundings, A unit of this type generally comprises two wiper blades that scrape the exterior surface of the windscreen so as to remove the water present on this surface. Spray jets are positioned on the vehicle bonnet or, in a more recent version, on the blades, and are supplied with window-washing liquid via a pump and a tube system that are connected to a window-washing liquid tank.

For the purpose of washing the windscreen, particularly in the absence of rain, such systems are conventionally equipped with a first tank containing a cleaning liquid, a tube system connecting the tank to spray jets, and a pump suitable for circulating the liquid in the tube system as far as the spray jets. With a view to de-icing the windscreen in cold weather, it is known to use the tube system and the spray jets of the washing system to circulate a de-icing liquid, originating from a second tank, instead of washing the liquid.

The two tanks may each have their own pump, but are generally connected to the same tube system that conveys one or other of the liquids to the spray jets through which the liquids are sprayed onto the windscreen. Thus, when de-icing liquid is to be sprayed onto the windscreen, the washing pump is deactivated and the de-icing pump activated.

De-icing liquid is more expensive than conventional cleaning liquids and it is important to spray only the amount strictly required for de-icing the windscreen. To that end, it is known to activate and to deactivate the motor and the pump used to spray this active liquid a number of times in the course of the rotation of the blades between their rest position and their high position on the windscreen. The interval between two consecutive activations is determined by the time required for the liquid to spread and to impregnate the ice present on the windscreen. Activation and deactivation are then triggered by the passage of the blade over predefined angular positions on the windscreen. The drawback of this solution, however, is that a great amount of stress is placed on this pump and the latter's service life is shortened.

The invention aims to improve the situation and to that end relates to a method for washing a window of a motor-vehicle, said vehicle being equipped with a device comprising:
at least one tank containing a fluid, preferably a de-icing fluid,
a tube system connecting the at least one tank to openings through which the fluid is sprayed onto the windscreen,
a supply pump designed to circulate the fluid in the tube system until it is ejected via the aforesaid openings, and
at least one wiper blade suitable for moving over the window between a low point and a high point through the action of a rotary-drive motor, characterized in that it comprises:
a) a division of the angular sector swept by said at least one blade into elementary sectors, and
b) over at least one of said elementary sectors, a modulation of the exit pressure from the supply pump between a “nominal” pressure and a non-zero reduced pressure that is less than this nominal pressure.

Preferably, the washing method is a method for de-icing a window.

The reduction in the exit pressure makes it possible to reduce the volume of liquid sprayed in order to adapt said volume to just the amount required for de-icing, utilizing the time that this liquid takes to act on the frost or ice. As a result, this allows a reduction in liquid consumption and thus allows savings to be made.

Advantageously, the reduced pressure is at least equal to 40% of the nominal value. This value provides significant savings and leaves the pump sufficiently reactive to return rapidly to its nominal flow rate.

Preferably, the exit pressure from said supply pump varies over said at least one of said elementary sectors from a reduced value to its nominal value and then from this nominal value to a reduced value. This sequence of pressure levels makes it possible, over an adapted time period, to deliver just the amount of liquid required to spread the liquid over the window and to save liquid by reducing the amount sprayed the rest of the time.

Advantageously, the exit pressure from said pump varies over each of the elementary sectors swept by said blade during the rise towards its high point, with the possible exception of an initial sector and of a completion sector, from a reduced value to its nominal value and then returns to its initial reduced value. The repetition of the sequence of cycles over each elementary sector guarantees a maximum saving in terms of consumption of the de-icing liquid.

Preferably, the method comprises, over said at least one of the elementary sectors, a modulation of the speed of rotation of the drive motor between a “nominal” speed and a non-zero reduced speed that is less than this nominal speed. Modulation of the speed of rotation of the blade makes it possible to impart to the blade a speed that is optimum in terms of the spreading of the liquid at the time when the latter is sprayed onto the window.

Advantageously, the reduced speed of rotation is at least equal to 50% of the nominal speed. This value leaves the drive motor sufficiently reactive to return rapidly to its nominal speed.

Preferably, the speed of rotation of the drive motor varies over said at least one of the elementary sectors from a reduced value to its nominal value and then from this nominal value to a reduced value. This sequence of speed levels makes it possible to impart to the blade a speed that is well adapted to the time of spreading of the liquid over the window.

Advantageously, the speed of rotation of said drive motor varies over each of the elementary sectors swept by said blade during the rise towards its high point (PH), with the possible exception of an initial sector and of a completion sector, from a reduced value to its nominal value and then returns to its initial reduced value,

Preferably, said speed of rotation of the drive motor is always nominal when the pressure of the supply pump is nominal. This concomitance of the nominal values guarantees that the de-icing liquid is sprayed onto the window when the blade turns at the speed best adapted to the spreading of this liquid.

More preferably, the speed of the drive motor is nominal prior to the exit pressure from the supply pump achieving its nominal value and/or after the reduction in said exit pressure relative to its nominal value. This offset makes it possible to achieve full wiper speed before the liquid is sprayed onto the window.

In a particular embodiment, the method is implemented during the rise of said blade towards the high point, a purge of the tube system being implemented as said blade descends again towards the low point.

The invention also relates to a device for washing a window of a motor-vehicle, comprising:
at least one tank containing a fluid, preferably a de-icing fluid,
a tube system connecting the at least one tank to openings through which the fluid is sprayed onto the window,
a supply pump designed to circulate the fluid in the tube system until it is ejected via the aforesaid openings, and
at least one wiper blade suitable for moving over the window through the action of a rotary-drive motor,
characterized in that it further comprises a control means capable of modulating the exit pressure from the supply pump between a “nominal” pressure and a non-zero reduced pressure that is less than this nominal pressure.

Advantageously, said control means is capable of modulating the speed of rotation of the drive motor of said wiper blade between a “nominal” speed and a non-zero reduced speed that is less than this nominal speed.

In a particular embodiment, the drive motor and/or the supply pump are of the do stepping type or of the reversible type, the speed of rotation and/or, respectively, the exit pressure of which are controlled by a modulation in the pulse width of their control signal.

Alternatively, regulation of the exit pressure from the pump may also be controlled by varying the supply voltage of said pump.

Advantageously, the washing method and the washing device according to the invention are implemented by virtue of liquid-spraying openings located on the windscreen wiper blades and/or on the actuating arms used to move these blades, Preferably, the windscreen wiper blades and/or the actuating arms comprise fluid-circulation channels provided with openings extending, respectively, along the blades or along the actuating arms.

Further features and advantages of the invention will become apparent on reading the following description and exemplary embodiments given by way of illustration with reference to the appended figures. In these figures:

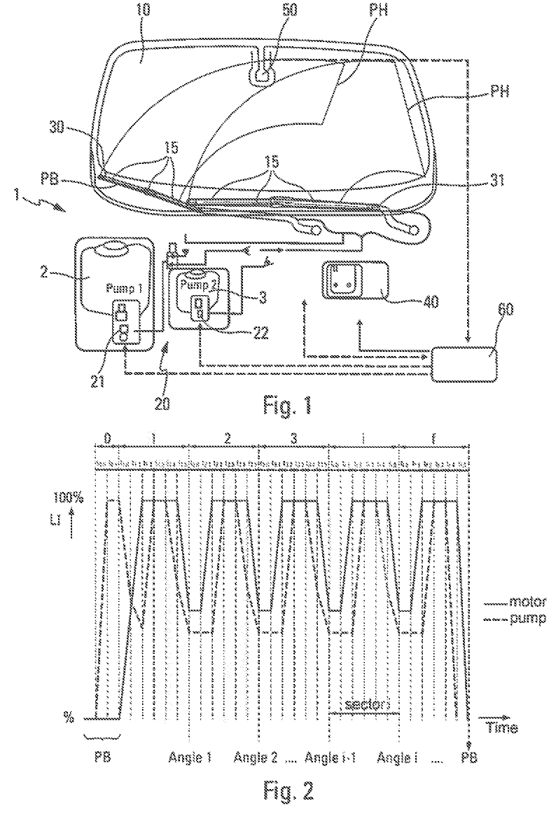

FIG. 1 is a schematic view of a device for washing a motor-vehicle windscreen;

FIG. 2 is a graph illustrating the various steps in an embodiment of the deicing method according to the invention.

Its The washing method of the invention uses a washing device 1 used on a motor-vehicle windscreen 10, as illustrated in FIG. 1. A washing device of this type comprises a first tank 2 containing a first fluid, such as a washing liquid, and a second tank 3 comprising a second fluid, such as a deicing liquid.

The washing device 1 also comprises a tube system 5 connecting the first tank 2 and the second tank 3 to openings 15 via which first fluid and/or second fluid is/are ejected onto the windscreen 10. It further comprises a pump system 20 designed to circulate first fluid and/or second fluid in the tube system 5 until it is ejected via the openings 15. The pump system 20 comprises, in this case, two independent pumps 21, 22. A first pump 21 is associated with the first tank 2 and is designed to circulate first fluid in the tube system 5, and a second pump 22 is associated with second tank 3 and is designed to circulate the second fluid in the tube system 5.

The washing device 1 comprises at least one wiper blade 30 mounted on an arm 31 and suitable for moving over the windscreen 10 between a low position PB and a high position PH. The washing device 1 of FIG. 1 comprises two wiper blades 30. The aforesaid openings 15 are, in this case, located along the entire length of the wiper blades 30. The openings 15 are arranged in such a manner as to spray first fluid and/or second fluid towards the top of the wiper blades 30, i.e. towards the top of the windscreen 10. The system could likewise be implemented with openings 15 located on either side of the windscreen wiper blade, liquid then being sprayed either only in the direction of the rise or only on the leading side of the blade. It is also possible for the openings 15 located on either side of the wiper blades 30 to spray the liquid simultaneously.

The washing device 1 also comprises a motor 40 designed to drive the wiper blades 30 between their respective low positions and their respective high positions. The washing device of FIG. 1 further comprises at least one sensor 50, although this configuration is not essential to the embodiment of the invention. This sensor is located, in this case, on a top part of the windscreen, in the centre thereof. It is, in particular, located in a zone of the windscreen 10 that is swept by just one of the two wiper blades 30. The sensor 50 may, in particular, be a temperature or rain sensor.

The washing device 1 further comprises an electronics unit 60 capable of controlling the motor 40 for driving the wiper blades 30 and the activation of the pump system 20, it being possible for the first and second pumps 21, 22 to be controlled independently. In the remainder of the description of the invention, the motor 40 for driving the windscreen wiper blades and the second pump 22 for supplying de-icing liquid are chosen as do stepping-type or reversible-type motors or pumps, the speed of rotation of which in the case of one and the exit pressure of which in the case of the other are controlled by a modulation in the pulse width of their control signal. Any other device may be envisaged, provided this speed and/or this exit pressure can be modulated.

FIG. 2 shows an embodiment of the method for de-icing a window according to the invention and is illustrated by a graph representing time t on the X axis and, on the Y axis, the pulse width (LI) of the drive motor 40 of the windscreen wiper blades 30 (continuous line) and that of the pump 22 for supplying the spray jets 15 with de-icing liquid (broken line).

It may be seen that the amplitude of the rotation of a blade between its low point PB (or rest position) and its high point PH (or position opposite the rest position) is broken down into a succession of angular sectors, the number and thus the angular amplitude of each of which is a function of the subtlety of control of the motor and of the pump that is sought. This angular amplitude, again, reflects a required time period sufficient for the de-icing liquid sprayed discretely over each elementary sector, to be able to spread and to impregnate the ice on the windscreen.

The operation of the drive motor 40 and of the de-icing pump 22 will be described with reference to a given elementary sector “i”, which extends between an angle i-1 and an angle i, which are measured from the low point P. The drive motor 40 and the supply pump 22 are controlled in an identical manner over the other sectors, this control scheme being repeated over the entire angular amplitude swept by the blades 30, except for the first sector, referenced 0, and the final sector, referenced f, the control of these two items of equipment being described later.

At the start of the elementary sector i, i.e. at the level of the angle i-1, the speed of the drive motor 40 and the exit pressure from the supply pump 22 are reduced by a control signal, the pulse width of which is, in the case of the motor, 50% and, in the case of the pump, 40% of the maximum value thereof. These reduced values are maintained over a period ti.0.

Next, at the end of the period ti.0, the pulse width sent to the control of the drive motor 40 is brought progressively to 100%, over a period ti.1 which corresponds to the maximum speed of response to the command to vary the motor operation. This pulse width is then maintained at 100% for a period equal to the sum of three periods ti,2, ti.3 and ti.4. Throughout this time, the speed of rotation of the drive motor 40 is at its maximum, i.e., for example, is equal to its nominal rotation value during use of the blades to wipe the windscreen. Beyond this time ti.4, the pulse width is returned to its reduced value of 50%, this being for a period ti.5.

In parallel, the pulse width given to the control signal of the supply pump 22 remains at its reduced value of 40% during the first period ti.1, running on from the initial period ti.0. It is then brought progressively to 100% over a period ti.2, which corresponds to the maximum pump control response speed. The pulse width is then maintained at 100% for a period equal to the period ti.3. Throughout this time, the exit pressure from the supply pump 22 is at its maximum, i.e., for example, is equal to its nominal pressure during use of the blades to wash the windscreen (except for implementation of the de-icing function).

Beyond this time, and for a period ti.4, which corresponds to the pump control device response time, the pulse width is initially brought back to a first reduced value, equal to 60% of the maximum value, and then, during a period ti.5, to an even lower value, equal to 40% of the maximum value of the pulse width. At the end of this period ti.5, the pulse widths of the drive motor 40 and of the supply pump 22 are brought back to the values they had at the start of the sector i and may follow a new cycle over a sector i+1.

All these—identical—cycles are preceded by an initial cycle, referenced “0”, and a completion cycle, referenced “t”.

In the rest position of the Wades, at the start of the initial cycle, the blades are stationary in the low position, the drive motor and the supply pump not running owing to the fact that a pulse width equal to zero has been transmitted to their control system. For a period t0.0 when the drive motor 40 is not permitted to run, the pulse width of the control of the supply pump 22 is progressively brought to 100%, this period t0.0 corresponding to the maximum speed of increase in the pulse width between 0 and 100%. This pulse width of 100% is maintained for a period t0.1, the time when the de-icing liquid spreads over the low part of the windscreen and melts the ice that has been able to accumulate there and to immobilize the blades 15. At the end of this period t0.1, and for a period equal to t1.0 and t1.1, the drive motor 40 is enabled by virtue of a progressive increase in the pulse width of its control signal from 0 to 100%. In parallel, the pulse width of the supply pump 22 is reduced from 100% to 60% and then 40% in the course, respectively, of the two periods t1.0 and t1.1, which correspond to the first two periods of the first de-icing the cycle according to the invention, this cycle being implemented over the angular sector of which the value i is equal to 1. The initial cycle and the first cycle are satisfactorily linked through an appropriate choice of the periods t1.0 and t1.1. The period t1.0 is such that the pulse of the motor reaches approximately 50% at the end of this period. The period t1.1 is chosen such that, at the end of this period, the pulse width of the drive motor 40 reaches 100% simultaneously with the pulse width of the supply pump 22 reaching the value of 40%.

In the course of the completion cycle “f”, the pulse amplitude of the control of the motor and the pulse amplitude of the control of the supply pump 22 are both at 100% after a period tf.3. These amplitudes will then be reduced separately, with, first, the pulse amplitude of the control signal of the supply pump 22 being brought to zero and, thus, to complete shutdown of the supply pump at the end of the period tf.4. Likewise, the reduction in the pulse amplitude of the drive motor 40 will be brought to the value zero and thus to complete shutdown of this motor between the end of the period tf.4 and the end the period tf.5.

The de-icing cycle on an outward sweep of the blade is thus terminated and the blade can then be brought back to its low point PB, in accordance with its conventional operation of wiping the windscreen. The return sweep is preferably used to purge de-icing liquid from the tube system 5, by means of enabling the washing pump 21. The liquid sprayed during this descent phase of the blade advantageously provides a protective film on the windscreen, which prevents the reappearance of frost thereon. Then, as a function of the condition of the windscreen, a new de-icing cycle may then be implemented during the next rise of the blade.

Alternatively, regulation of the pressure at the exit from the pump may also be controlled by varying the supply voltage of said pump.

The operation of the de-icing cycle of a windscreen, according to the invention, is presented thus, except for the initial and completion cycles:

The angular sector swept by each of the blades is broken down into consecutive elementary sectors of which the amplitude corresponds to the efficiency required for spreading a given amount of de-icing liquid over this elementary sector and for said liquid to impregnate the ice, account being taken of a slowed speed in terms of the rotation of the blades.

The drive motor 40 is successively brought to its maximum speed, by a increase to 100% of the pulse width of its control signal, and then maintained at this value for three periods ti.2, ti.3 and ti.4. The period ti.2 corresponds to the period required for increasing the pulse width of the control signal of the supply pump 22 from its reduced value to the value of 100%. The period ti.3 corresponds to the time required for the desired amount of de-icing liquid to be delivered to the openings 15 of the blade. Lastly, the period ti.4 corresponds to the slowdown period of the pump, which is the result of the reduction in the pulse width of its control signal from 100% to 60%, a pulse amplitude of its control signal of 40% being achieved at the end of the period ti.5. During the period ti.4, de-icing liquid is still conveyed abundantly by the supply pump, and the speed of rotation of the motor 40 for driving the blades is maintained at its maximum value. It will be noted that the drive motor 40 is always operating at its maximum when the supply pump 22 is brought to its maximum exit pressure, in order to ensure satisfactory distribution of the de-icing liquid over the elementary sector in question. Moreover, the period during which the supply pump 22 is operating at its maximum pressure is shorter than the period during which the motor 40 is operating at its maximum pressure, a period during which the supply pump 22 is at its maximum pressure being preceded and followed by a period of maximum rotation of the drive motor. The sequence of these maximum operation and exit pressure periods guarantees good distribution of the de-icing liquid, with optimum efficiency in terms of impregnation of the ice, resulting in a reduction of the required amount of de-icing liquid.

The pulse width of the control signal of the drive motor 40 is then brought to a reduced value (typically, 50%, although this value is not a prerequisite), which corresponds to a slower rotation of the blade. This reduced speed corresponds to a phase of spreading the de-icing liquid over the elementary sector in question and of impregnation of the ice, to allow this liquid time to act.

The pulse widths of the drive motor 40 and of the supply pump 22 are maintained, for a time, at their reduced values prior to the re-enabling of a new de-icing cycle over the next elementary sector, the pulse width of the drive motor and then that of the supply pump being re-enabled.

At the end of the de-icing cycle, when the blade arrives close to its high point PH, the cycle over the last elementary sector “f” simply consists in bringing the pulse widths of the control signals of the two items of equipment to zero, stopping the delivery of the de-icing liquid and halting the rotation of the drive motor.

Ultimately, this management of the pressure imparted to the supply pump and of the speed of the drive motor allows substantial savings in terms of consumption of the de-icing liquid without the quality of de-icing being adversely affected.

1. A method for washing a window of a motor vehicle, said vehicle being equipped with a device comprising:
at least one tank containing a de-icing fluid;
a tube system connecting the at least one tank to openings through which the fluid is sprayed onto the windscreen;
a supply pump designed to circulate the fluid in the tube system until it is ejected via the aforesaid openings; and
at least one wiper blade suitable for moving over the window between a low point and a high point through the action of a rotary-drive motor, the method comprising:
a) a division of the angular sector swept by said at least one blade into elementary sectors, and
b) over at least one of said elementary sectors, a modulation of the exit pressure from the supply pump between a “nominal” pressure and a non-zero reduced pressure that is less than this nominal pressure.

2. The method according to claim 1, wherein the reduced pressure is at least equal to 40% of the nominal value.

3. The method according to claim 1, wherein the exit pressure from said supply pump varies over said at least one of said elementary sectors from a reduced value to its nominal value and then from this nominal value to a reduced value.

4. The method according to claim 3, wherein the exit pressure from said pump varies over each of the elementary sectors swept by said blade during the rise towards its high point, with the possible exception of an initial sector and of a completion sector, from a reduced value to its nominal value and then returns to its initial reduced value.

5. The method according to claim 1, further comprising, over said at least one of the elementary sectors, a modulation of the speed of rotation of the drive motor between a “nominal” speed and a non-zero reduced speed that is less than this nominal speed.

6. The method according to claim 5, wherein the reduced speed of rotation is at least equal to 50% of the nominal speed.

7. The method according to claim 5, wherein the speed of rotation of the drive motor varies over said at least one of the elementary sectors from a reduced value to its nominal value and then from this nominal value to a reduced value.

8. The method according to claim 7, wherein the speed of rotation of said drive motor varies over each of the elementary sectors swept by said blade during the rise towards its high point, with the possible exception of an initial sector and of a completion sector, from a reduced value to its nominal value and then returns to its initial reduced value.

9. The method according to claim 5, wherein said speed of rotation of the drive motor is always nominal when the pressure of the supply pump is nominal.

10. The method according to claim 9, wherein the speed of the drive motor is nominal prior to the exit pressure from the supply pump achieving its nominal value and/or after the reduction of said exit pressure relative to its nominal value.

11. The method according to claim 1, wherein the method is implemented during the rise of said blade towards the high point, a purge of the tube system being implemented during the descent of said blade towards the low point.

12. A device for washing a window of a motor vehicle, comprising:
at least one tank containing a de-icing fluid;
a tube system connecting the at least one tank to openings through which the fluid is sprayed onto the window;
a supply pump designed to circulate the fluid in the tube system until the fluid is ejected via the aforesaid openings;
at least one wiper blade suitable for moving over the window through the action of a rotary-drive motor; and
a control means capable of modulating the exit pressure from the supply pump between a “nominal” pressure and a non-zero reduced pressure that is less than this nominal pressure.

13. The device according to claim 12, wherein said control means is capable of modulating the speed of rotation of the drive motor of said wiper blade between a “nominal” speed and a non-zero reduced speed that is less than this nominal speed.

14. The device according to claim 12, wherein the drive motor and/or the supply pump are of the dc stepping type or of the reversible type, wherein the speed of rotation of the drive motor and/or, respectively, the exit pressure from the supply pump are controlled by a modulation of the pulse width of their control signal.
